(19) United States
(12) Patent Application Publication
(10) Pub. No.: US 2008/0207474 A1
(43) Pub. Date: Aug. 28, 2008

(54) Method and system for detecting leaks in stuffing box of two-stroke engines

(76) Inventors: Klaus-Werner Damm, Virginia Beach, VA (US); Richard Leahy, East Yorkshire (GB)

Correspondence Address: Sharon B. McLullen, 1701 Market Street, Philadelphia, PA, 19103, US

(21) Appl. No.: 12/001,433

(22) Filed: Dec. 11, 2007

Related U.S. Application Data
(60) Provisional application No. 60/874,091, filed on Dec. 11, 2006.

(51) Int. Cl. C10M 169/04; G01M 3/04; G01N 23/223

(52) U.S. Cl. 508/391; 73/40; 378/47

(57) ABSTRACT

The present invention provides for a method for detecting leaks in a stuffing box of a two-stroke engine. Blended cylinder oil is produced by blending base fluid, at least one additive and a metal source having a first concentration. The metal source includes metals other than calcium and transition metals. The engine is operated by supplying the blended cylinder oil and a fuel to the engine cylinder. The concentration of the metal source is monitored using x-ray fluorescence spectroscopy (“XRF”) to obtain a second concentration of the metal source. The first concentration of the metal source is compared to the second concentration of the metal source.

### RELATED APPLICATIONS

This application claims the benefit of U.S. Provisional Application No. 60/874,091, filed Dec. 11, 2006.

### FIELD OF THE INVENTION

The invention relates to a method for detecting leaks in stuffing boxes using x-ray fluorescence spectroscopy.

### BACKGROUND OF THE INVENTION

Two-stroke crosshead engines used in marine or stationary applications are equipped with two separate lubricating oil systems. One lubricating system includes so-called system oil that is used in the engine crank case for lubrication and cooling of the engine's bearings and oil-cooled pistons as well as for activation and/or control of various valves or the like. Typical system oils usually have an SAE viscosity of about 30 with a relatively low TBN content, typically below 10. These exemplary values may vary dependent on the actual application and the specific design of the systems that the oils are used in.

The other lubricating system, of a two-stroke crosshead engine, includes an all-loss lubricant (cylinder oil) that normally is used for lubrication of the engine's cylinders, piston rings and piston skirt. Typically cylinder oil is spent continuously by each turn of the engine whereas the system oil in principle is not spent (except by smaller unintentional leakages). The lubrication system comprising the cylinder oil is also often referred to as an “all-loss” lubrication system as the oil is spent. Cylinder oil typically contains certain additives that function to reduce, minimize or neutralise the acid level of the cylinder system. Generally, cylinder oils have an SAE (Society of Automotive Engineering) viscosity equivalent to about 50 and normally have a total base number (TBN) of about 40 to 70 for the neutralisation of acid products produced during the combustion process.

The performance properties of lubricants, in two-stoke engines, is typically measured periodically. The properties may not go beyond certain limits without jeopardizing the condition of the oiled engine component. An important cause of performance loss is caused by particle contamination. These particles include combustion by-products and wear components, which can be partially removed by oil separators. However, in the case of two-stroke cross-head engines, one of the sources of contamination is spent cylinder oil leakage past the stuffing box causing both the viscosity and base number of the system oil to increase over time, a process that cannot be reversed by separators.

The present invention addresses a method for detecting stuffing box leaks.

### SUMMARY

The present invention provides for a method for detecting leaks in a stuffing box of a 2-stroke engine. Blended cylinder oil is produced by blending base fluid, at least one additive and a metal source having a first concentration. The metal source includes metals other than calcium and transition metals. The engine is operated by supplying the blended cylinder oil and a fuel to the engine cylinder. The concentration of the metal source is monitored using x-ray fluorescence spectroscopy (“XRF”) to obtain a second concentration of the metal source. The first concentration of the metal source is compared to the second concentration of the metal source.

The invention further provides for a composition suitable for use in the above method. The composition includes a fluid of lubricating viscosity and a mixture of at least two of the following metal-organic detergent additives: non-overbased or overbased total base number (“TBN”) calcium phenate; non-overbased or overbased TBN calcium sulphonate; non-overbased or overbased TBN calcium salicylate, or any combination thereof, wherein the at least two additives have a weight ratio ranging from 90:10 to 99.9:0.1; and a metal source having a first concentration. The metal source includes metals other than calcium and transition metals.

### BRIEF DESCRIPTION OF THE DRAWINGS

These and other aspects of the invention will be apparent from and elucidated with reference to the illustrative embodiments shown in the drawing, in which:

FIG. 1 shows a schematic block diagram of one embodiment according to the present invention; and

FIG. 2 shows a schematic block diagram of another embodiment according to the present invention.

### DESCRIPTION OF PREFERRED EMBODIMENTS

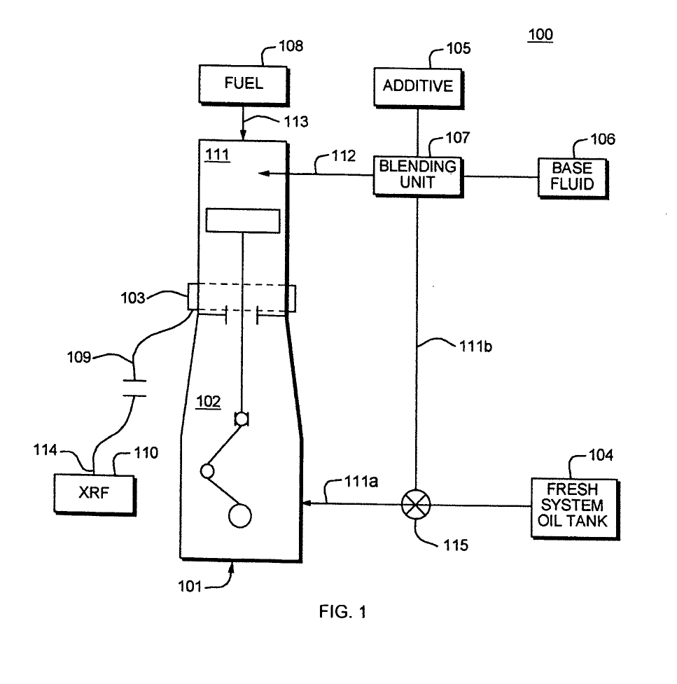

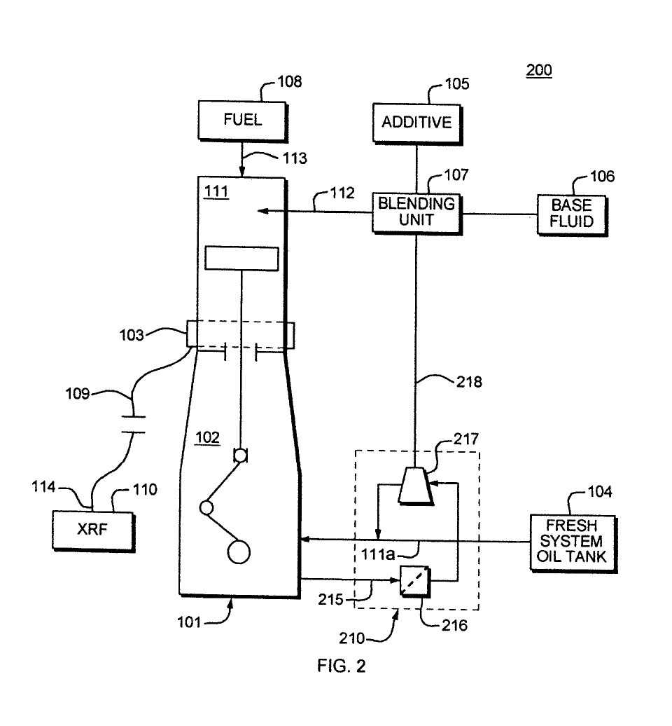

The present invention provides for a method of detecting leaks in a stuffing box of a 2-stroke engine. The method may be performed using the exemplary systems illustrated in FIGS. 1 and 2.

FIG. 1 shows a schematic representation of an exemplary system 100 having at least one two-stroke cross-head diesel engine 101 and an x-ray fluorescence spectrometer. The engine 101 includes a first lubricating system containing system oil used in the crankcase section 102 and a second lubricating system including an all-loss lubricant or cylinder oil used in the cylinder section 111. System 100 further includes stuffing box 103, fresh system oil tank 104, additive tank 105, base fluid tank 106, blending unit 107, fuel tank 108, stuffing box drain 109, stuffing box sample point 114, system oil conduit line 111a and 111b, valve 115, cylinder oil conduit line 112 and fuel conduit 113 for carrying out the present invention. Base fluid tank 106 holds base fluid which is blended, in blending unit 107, with additives held in additive tank 105 to form blended cylinder oil. The blended cylinder oil is transferred to the cylinder section 111 of the two stroke engine 101 where it is mixed with fuel held in fuel tank 108.

FIG. 2 shows a schematic representation of an exemplary system 200 wherein system oil is recycled to produce blended cylinder oil. The system oil recycle unit 210 includes a used system oil recycle loop 215, filter 216, separator 217, and used system oil conduit line 218. System oil which has been used by the two-stroke engine 101 is transferred via used system oil recycle loop 215 to filter 216 and then to separator 217. At least some of the used system oil may then be transferred to blending unit 107 via used system oil conduit line 218 for blending with additives from additive tank 105. The remaining used system oil may be recycled back to the two-stroke engine 101 and fresh system oil from fresh system oil tank 104, added to make up any deficient.

XRF is used to detect leaks of cylinder oil from the stuffing box. In XRF spectroscopy, the metal source is identified by the energy spectra of photons that are emitted by fluorescence process. By measuring the energy and number of the emitted photons, the identity and quantity of a metal may be determined. According to an embodiment of the present invention, blended cylinder oil is produced by blending base fluid at least one additive and a metal source having a first concentration in the blended cylinder oil. A reference XRF spectrum of the blended cylinder oil is obtained. The metal source includes metals other than calcium and transition metals. The engine 101 is operated by supplying the blended cylinder oil, via conduit 112, and a fuel, via fuel conduit 113, to the engine cylinder section 111. During engine operation, the concentration of the metal source, in the blended cylinder oil, is monitored using XRF.

To monitor the metal source concentration, fluid may be drained from stuffing box 103 via drain line 109 and sample point 114 and analyzed periodically using the XRF which generates a monitored XRF spectrum. Using the reference and monitored XRF spectra to determine metal concentrations, a comparison is then made between the concentrations of the metal source in the blended oil against concentration of the metal source of the oil drained from the stuffing box. A stuffing box leak is indicated when the metal source in the blended cylinder oil is greater than the metal concentration in the drained fluid. In another embodiment, comparison may be between the ratio of Ca to metal source in the blended oil against the ratio of Ca to metal source of the oil drained from the stuffing box. A stuffing box leak is indicated when the ratio of Ca to metal source in the blended cylinder oil differs from the ratio of Ca to metal source in the drained fluid.

A composition suitable for use in the above method includes a fluid of lubricating viscosity and a mixture of at least two of the following metal-organic detergent additives: non-overbased or overbased TBN calcium phenate; non-overbased or overbased TBN calcium sulphonate; non-overbased or overbased TBN calcium salicylate, or any combination thereof wherein the at least two additives have a weight ratio ranging from 90:10 to 99.9:0.1; and a metal source having a first concentration. The metal source includes metals other than calcium and transition metals. A metal-organic detergent additive typically has a metal to organic anion mole ratio of 1:1 for Group IA metals and 0.5:1 for Group IIA metals. In one embodiment of the present invention, a non-overbased metal-organic detergent additive has a metal to organic anion mole ratio ranging from 0.2:1 to 1:1 for Group IA metals and a metal to organic anion mole ratio ranging from 0.1:1 to 0.5:1 for Group IIA metals. In another embodiment of the present invention, a non-overbased metal-organic detergent additive has a metal to organic anion mole ratio ranging from 0.3:1 to 0.8:1 for Group IA metals and a metal to organic anion mole ratio ranging from 0.2:1 to 0.3:1 for Group IIA metals. In one embodiment of the present invention, an overbased metal-organic detergent additive has a metal to organic anion mole ratio ranging from 1:1 to 8:1 for Group IA metals and a metal to organic anion mole ratio ranging from 0.5:1 to 4:1 for Group IIA metals. In another embodiment of the present invention, an overbased metal-organic detergent additive has a metal to organic anion mole ratio ranging from 2:1 to 6:1 for Group IA metals and a metal to organic anion mole ratio ranging from 1:1 to 3:1 for Group IIA metals.

In one embodiment, the metal source is selected from the group consisting of an organometallic, an organic metal salt and an overbased metal detergent. In another embodiment, the metal source contains a metal selected from the group of metals consisting of Group 1A and Group 2A. In yet another embodiment, the metal source contains barium. The metal salts may belong to the inorganic chemical families of e.g. oxides, hydroxides, carbonates, sulfates or the like.

The base fluid may include base oil, system oil, used system oil, trunk piston engine oil, or used trunk piston engine oil. In one embodiment, the base fluid has a viscosity in the range of 9 cSt to 30 cSt at 100° C. In one such embodiment, fresh system oil may be obtained from fresh system oil tank 104 and transferred to blending apparatus 107 via fresh system oil conduit 111b. In another embodiment, base oil, trunk piston engine oil or used trunk piston engine oil may be obtained from base fluid tank 106 and transferred to the blending apparatus 107.

In yet another such embodiment, used system oil may be used to produce blended cylinder oil as illustrated in FIG. 2. The used system oil may be obtained from the crank case section 102 of the 2-stroke engine 101, transferred to blending apparatus 107 via used system oil recycle loop 215, filter 216, separator 217, and used system oil conduit line 218. The two-stroke engine, from which the used system oil is obtained, may be tapped continuously, near-continuously or intermittently for used system oil and the used system oil is replenished with fresh system oil.

In one embodiment, the additives include detergents such as phenate, sulphonate or salicylate salts. For an embodiment where the detergent includes calcium phenate as an additive, the calcium phenate has a TBN ranging from 20 TBN to 250 TBN. In another embodiment, the calcium phenate has a mole ratio of metal to phenate ranging from 0.2:1 to 1.5:1 for a Group IA metal and ranging from 0.1:1 to 0.5:1 for a Group IIA metal. In yet another embodiment, the calcium phenate has a mole ratio of metal to phenate ranging from 0.5:1 to 1:1 for a Group IA metal and ranging from 0.3:1 to 0.5:1 for a Group IIA metal.

For an embodiment where the detergent includes calcium sulphonate as an additive, the calcium sulphonate has a TBN ranging from 10 TBN to 300 TBN. In another embodiment, the calcium sulphonate has a mole ratio of metal to sulphonate ranging from 0.2:1 to 2:1 for a Group IA metal and ranging from 0.1:1 to 0.5:1 for a Group IIA metal. In yet another embodiment, the calcium sulphonate has a mole ratio of metal to sulphonate ranging from 0.5:1 to 1.5:1 for a Group IA metal and ranging from 0.3:1 to 0.5:1 for a Group IIA metal.

For an embodiment where the detergent includes calcium salicylate, the calcium salicylate has a TBN ranging from 10 TBN to 200 TBN. In another embodiment, the calcium salicylate has a mole ratio of metal to salicylate ranging from 0.2:1 to 2:1 for a Group IA metal and ranging from 0.1:1 to 0.5:1 for a Group IIA metal. In yet another embodiment, the calcium salicylate has a mole ratio of metal to salicylate ranging from 0.5:1 to 1.5:1 for a Group IA metal and ranging from 0.3:1 to 0.5:1 for a Group IIA metal.

The composition may also contain dispersants belonging to the organic chemical families of succinimides or the like.

The creation of the blended cylinder oil according to the present invention is well suited for on-site creation such as a marine vessel, off-shore equipment, stationary plants, etc.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

What is claimed:

1. A method for detecting leaks in a stuffing box of a 2-stroke engine, comprising:
(a) producing a blended cylinder oil by blending a base fluid, at least one additive and a metal source having a first concentration, said metal source comprising metals other than calcium and transition metals;
(b) operating the engine by supplying the blended cylinder oil and a fuel to the engine cylinder;
(c) monitoring a second concentration of the metal source using x-ray fluorescence spectroscopy (XRF); and
(d) comparing the first concentration of the metal source to the second concentration of the metal source.

2. The method of claim 1, wherein the base fluid is selected from the group consisting of: base oil, system oil, used system oil, trunk piston engine oil, or used trunk piston engine oil.

3. The method of claim 1, wherein the at least one additive is selected from the group consisting of detergents, anti-oxidants, and friction modifiers.

4. The method of claim 1, wherein said additive includes one or more of the following metal-organic detergent additives: (i) non-overbased or overbased TBN calcium phenate, (ii) non-overbased or overbased TBN calcium sulphonate, (iii) non-overbased or overbased TBN calcium salicylate, or any combination thereof, wherein the at least two additives have a weight ratio ranging from 90:10 to 99.9:0.1.

5. The method of claim 1, wherein said metal source is selected from the group consisting of an organometallic, an organic metal salt, and an overbased metal detergent.

6. The method of claim 1, wherein the metal source contains a metal selected from the group of metals consisting of Group IA and Group IIA.

7. The method of claim 6, wherein the metal source contains barium.

8. The method of claim 1, wherein the 2-stroke engine is operated on a marine vessel.

9. The method of claim 8, wherein said blending is performed on the marine vessel.

10. The method of claim 8, wherein said blending is not performed on the marine vessel.

11. A composition suitable for use as a cylinder oil in 2-stroke engines containing a base fluid of lubricating viscosity, a mixture of at least two of the following metal-organic detergent additives: (i) non-overbased or overbased TBN calcium phenate, (ii) non-overbased or overbased TBN calcium sulphonate, (iii) non-overbased or overbased TBN calcium salicylate, or any combination thereof, wherein the at least two additives have a weight ratio ranging from 90:10 to 99.9:0.1, and a metal source having a first concentration, said metal source comprising metals other than calcium and transition metals.

12. The composition of claim 11, wherein the base fluid has a viscosity in the range of 9 cSt to 30 cSt at 100° C.

13. The composition of claim 11, wherein the calcium phenate has a TBN ranging from 20 TBN to 250 TBN.

14. The composition of claim 11, wherein the calcium phenate has a mole ratio of metal to phenate ranging from 0.2:1 to 1.5:1 for a Group IIA metal and ranging from 0.1:1 to 0.5:1 for a Group IIA metal.

15. The composition of claim 11, wherein the calcium sulphonate has a TBN ranging from 10 TBN to 300 TBN.

16. The composition of claim 11, wherein the calcium sulphonate has a mole ratio of metal to phenate ranging from 0.1:1 to 2:1 for a Group IIA metal and ranging from 0.1:1 to 0.5:1 for a Group IIA metal.

17. The composition of claim 11, wherein the calcium salicylate has a TBN ranging from 10 TBN to 200 TBN.

18. The composition of claim 11, wherein the calcium salicylate has a mole ratio of metal to phenate ranging from 0.1:1 to 2:1 for a Group IA metal and ranging from 0.1:1 to 0.5:1 for a Group IIA metal.
